(19) United States
(12) Patent Application Publication
(10) Pub. No.: US 2019/0264700 A1
(43) Pub. Date: Aug. 29, 2019

(54) DEVICES, SYSTEMS, AND METHODS FOR CONTROLLING A CEILING FAN

(71) Applicant: TTI (MACAO COMMERCIAL OFFSHORE) LIMITED, Macau (MO)

(72) Inventors: Mark Huggins, Anderson, SC (US); Scott P. Kippes, Piedmont, SC (US); Alexandra E. Giles, Greenville, SC (US); Casey R. Izard, Easley, SC (US)

(21) Appl. No.: 16/288,172

(22) Filed: Feb. 28, 2019

Related U.S. Application Data
(60) Provisional application No. 62/636,263, filed on Feb. 28, 2018.

(51) Int. Cl. F04D 27/00; F04D 25/08; F04D 29/36; B05B 15/60

(52) U.S. Cl. CPC F04D 27/004; F04D 25/088; B05B 15/60; F04D 29/36; F04D 27/008; F04D 27/002

(57) ABSTRACT

Devices, systems, and methods for controlling a ceiling fan are disclosed. One example system may include a sensor device and a remote device. The remote device may be configured to generate an instruction based on the data obtained from the sensor device, and transmit the instruction via the communications network to a fan. The fan may include a hub, a plurality of fan blades extending from the hub, and a motor supported by the hub. The fan may further include a wireless transceiver supported by the hub. The wireless transceiver may be configured to access the communications network for communicating with the remote device. The fan may further include an electronic processor supported by the hub. The electronic processor may be configured to control an operation of the fan based on receiving the instruction from the remote device via the wireless transceiver.

### CROSS REFERENCE TO RELATED APPLICATIONS

This application claims priority to U.S. Provisional Patent Application No. 62/636,263 filed Feb. 28, 2018, the entire contents of which are incorporated herein by reference.

### BACKGROUND

The present subject matter relates to fans and, in particular, ceiling fans.

Ceiling fans may be used to circulate air within rooms. Some ceiling fans may be wired to a switch to allow a user to enable/disable operation of the ceiling fan using the switch. Some ceiling fans may include a pull chain to allow a user to adjust settings of the ceiling fan (e.g., a speed at which blades of the ceiling fan rotate).

### SUMMARY

In one embodiment, a system may include a sensor device and a remote device communicatively coupled to the sensor device. The remote device may be configured to obtain data from the sensor device, and generate an instruction based on the data obtained from the sensor device. The remote device may be further configured to access a communications network, and transmit the instruction via the communications network. The system may further include a fan connected to the communications network. The fan may include a hub, a plurality of fan blades extending from the hub, and a motor supported by the hub. The motor may be configured to rotate the plurality of fan blades. The fan may further include a wireless transceiver supported by the hub. The wireless transceiver may be configured to access the communications network for communicating with the remote device. The fan may further include an electronic processor supported by the hub. The electronic processor may be configured to control an operation of the fan based on receiving the instruction from the remote device via the wireless transceiver.

In another embodiment, a method of controlling a fan including a hub, a plurality of fan blades extending from the hub, and a motor supported by the hub and configured to rotate the plurality of fan blades is provided. The method may include obtaining, with a remote device communicatively coupled to a sensor device, data from the sensor device. The method may further include generating, with the remote device, an instruction based on the data obtained from the sensor device. The method may further include accessing, with the remote device, a communications network. The method may further include transmitting, with the remote device, the instruction via the communication network to a wireless transceiver of the fan. The wireless transceiver may be configured to access the communications network for communicating with the remote device. The fan may include an electronic processor being configured to control an operation of the fan based on receiving the instruction from the remote device via the wireless transceiver.

In one embodiment, a fan may include a hub and a plurality of fan blades extending from the hub. The fan may further include a motor supported by the hub. The motor may be configured to rotate the plurality of fan blades. The fan may further include a wireless transceiver supported by the hub and configured to communicate with a remote device over a communications network. The fan may further include an electronic processor configured to control an operation of the fan based on receiving an instruction from the remote device via the wireless transceiver. The instruction may be generated by the remote device based on data obtained from a sensor device, and the instruction may be transmitted by the remote device to the wireless transceiver via the communications network.

In another embodiment, a fan may include a hub having an inlet and a nozzle in fluid communication with the hub. The nozzle may have an outlet. The fan may further include an impeller positioned within the hub, and a motor supported by the hub. The motor may be configured to rotate the impeller to draw air into the hub through the inlet and propel air out of the nozzle through the outlet. The fan may further include a wireless transceiver supported by the hub and configured to communicate with a remote device over a communications network. The fan may further include an electronic processor configured to control an operation of the fan based on receiving an instruction from the remote device via the wireless transceiver. The instruction may be generated by the remote device based on data obtained from a sensor device, and the instruction may be transmitted by the remote device to the wireless transceiver via the communications network.

Other aspects of the present subject matter will become apparent by consideration of the detailed description and accompanying drawings.

### BRIEF DESCRIPTION OF THE DRAWINGS

FIG. 1A illustrates a system for controlling a ceiling fan according to one example embodiment.

FIGS. 1B and 1C illustrate a bladeless ceiling fan according to one example embodiment.

FIG. 2 is a block diagram of the remote device of FIG. 1A according to one example embodiment.

FIG. 3 is a block diagram of the ceiling fan of FIG. 1A according to one example embodiment.

FIG. 4 is a flowchart of a method of controlling the ceiling fan of FIG. 3 with the remote device of FIG. 2 according to one example embodiment.

FIGS. 5A and 5B illustrate the system of FIG. 1A employing a blade lock control for the ceiling fan of FIG. 1A according to one example embodiment.

FIGS. 6A-6C illustrate the system of FIG. 1A employing a fan blade pitch angle control for the ceiling fan of FIG. 1A according to one example embodiment.

FIG. 7 is a flowchart of a method of controlling the ceiling fan of FIG. 1A based on detecting an impact according to an example embodiment.

FIG. 8 is a flowchart of a method of employing a backup battery control for the ceiling fan of FIG. 1A according to one example embodiment.

FIG. 9 is a flowchart of a method of controlling the ceiling fan of FIG. 1A based on a temperature input according to one example embodiment.

FIG. 10 is a flowchart of a method of optimizing circulation for a space based on determining an optimal ceiling fan for the space according to one example embodiment.

FIG. 11 is a flowchart of a method of controlling the ceiling fan of FIG. 1A to generate a desired airflow based on user inputs according to one example embodiment.

Before any embodiments are explained in detail, it is to be understood that the present subject matter is not limited in its application to the details of construction and the arrangement of components set forth in the following description or illustrated in the following drawings. The present subject matter is capable of other embodiments and of being practiced or of being carried out in various ways.

### DETAILED DESCRIPTION

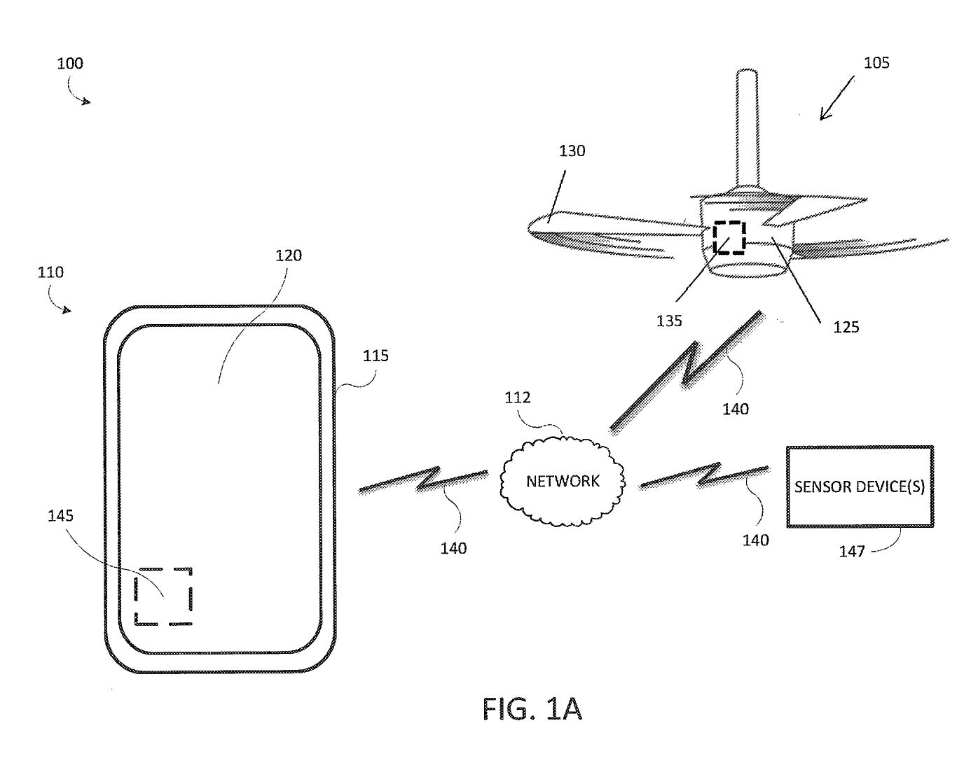

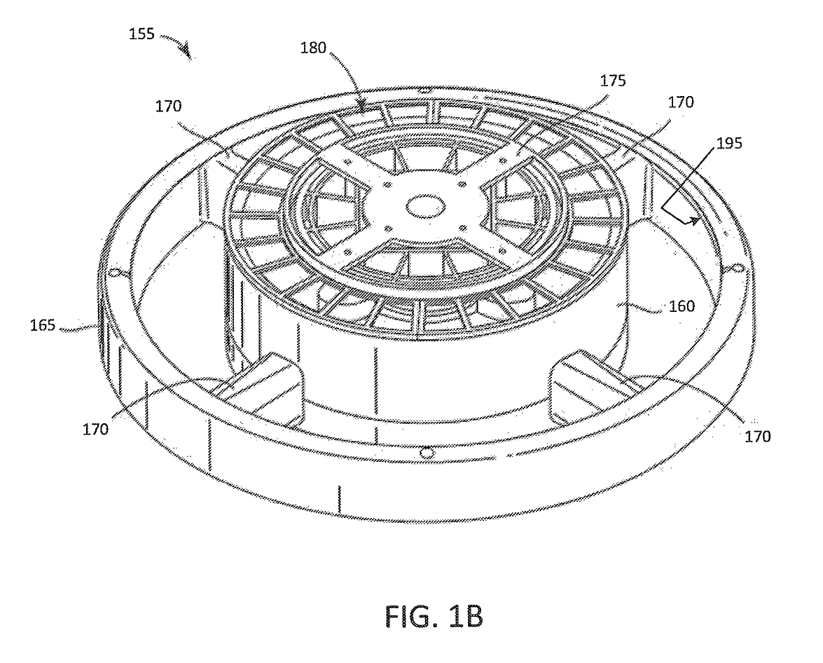

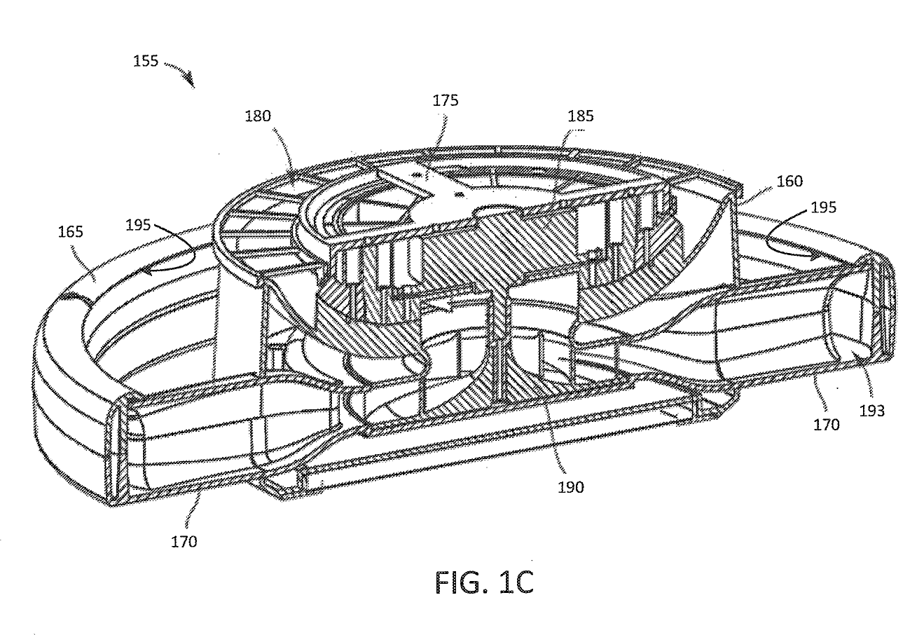

FIG. 1A illustrates a system, generally designated 100, for controlling a ceiling fan. The system 100 may include a ceiling fan 105 and a remote device 110 according to some embodiments. The remote device 110 may include a communication and/or computing device such as, for example, a smartphone, a handheld computer, a tablet computer, a laptop computer, a desktop computer, a wearable communication device (e.g., a smart wristwatch, a pair of smart eyeglasses,) a gaming device, a fob, a remote control, and/or the like. The remote device 110 may include a discrete device having one or more interfaces, applications, services, and/or the like that enable the remote device 110 to communicate with the ceiling fan 105 by way of a network 112 (e.g., a wired and/or wireless network, a communications network, a cellular network, a PLMN, a LAN, a WAN, a MAN, a PSTN, a private network, an intranet, the Internet, a fiber optic based network, a mesh network, and/or a combination of these or other types of networks), as described herein.

As an example, and in some embodiments, the remote device 110 is a smartphone that controls the ceiling fan 105 by way of executing a software application that is stored on the smartphone as described herein. As another example, and in some embodiments, the remote device 110 is an intelligent remote control that controls the ceiling fan 105 by way of executing a software application that is stored on the remote control as described here. As a further example, and in some embodiments, the remote device 110 is a computer that controls the ceiling fan 105 by way of a user entering instructions when logged into a web-based portal or a website as described herein. Other types of remote devices 110 are contemplated.

The remote device 110 may enable a user to control one or more fan outputs, states, functions, parameters, and/or the like being implemented by the ceiling fan 105 by way of the user interacting with a user interface 120 (e.g., a screen, a touchscreen, a display, a button, a key, a sensor, and/or the like) of the remote device 110. As shown in FIG. 1A, the remote device 110 may include a housing 115 disposed least partially around and/or retaining portions of the user interface 120 (e.g., a graphical user interface, a text-based user interface, and/or the like as indicated above). The user interface 120 may provide information for display. In some embodiments, the user may interact with the information being displayed, such as by providing input via an input component (e.g., a keypad, a keyboard, a mouse, a touchscreen, a microphone, and/or the like) of the remote device 110. In some embodiments, the ceiling fan 105 performance outputs (e.g., a motor output, a rotational speed output, a light output, a scent output, and/or the like), states (e.g., an on/off state, a blade unlocked/locked state, and/or the like), functions (e.g., a locking function, a light dimming function, and/or the like), parameters (e.g., a fan blade tilt angle parameter, a fan blade airflow parameter, a rotational direction, and/or the like), and/or the like may be altered or controlled based on such user input. In some embodiments, the one or more fan outputs, states, functions, parameters, and/or the like being implemented by the ceiling fan 105 may be controlled based on input received from one or more sensors or sensor devices (e.g., a temperature sensor, an impact sensor, an optical sensor, a motion sensor, and/or the like) disposed on the remote device 110, the ceiling fan 105, or a surface or structure in which the remote device 110 and/or the ceiling fan 105 are located.

Still referring to FIG. 1A, the ceiling fan 105 may include a hub 125 and a plurality of fan blades 130 extending outwardly from the hub 125. The ceiling fan 105 may be mountable to a ceiling or other overhead structure and/or surface in a room or area to create airflows within the room or area. Controlling such airflows as described herein may be useful for improved heating of the room, improved cooling of the room, improved drying of objects in the room (e.g., improved drying of floors, rugs, carpets, and/or the like), and/or the like. Aspects of the present subject matter, however, may be applied to other types of fans, such as bladeless ceiling fans, pedestal fans, tabletop fans, box fans, window fans, floor fans, and/or the like.

FIGS. 1B and 1C illustrate an example fan that may be included in system 100 (FIG. 1A). In some embodiments, the ceiling fan 105 of FIG. 1A may be provided as a bladeless ceiling fan 155 and/or incorporate a bladeless ceiling fan 155. The bladeless ceiling fan 155 may include a central hub 160, a nozzle 165, and one or more conduits 170 connecting the nozzle 165 and the central hub 160. The central hub 160 may be generally cylindrical in shape and may include a mount 175 for securing the bladeless ceiling fan 155 to a ceiling, structure, or surface. The central hub 160 may define an inlet 180 for pulling or otherwise directing outside air into the bladeless ceiling fan 155 so that the outside air may pass through and/or be expelled from the bladeless ceiling fan 155.

As shown in the cross-sectional view of the bladeless ceiling fan 155 in FIG. 1C, the bladeless ceiling fan 155 may include a motor 185 and an impeller 190 positioned within the central hub 160. When the motor 185 is energized, the motor 185 may rotate the impeller 190. As the impeller 190 rotates, the impeller 190 may draw air into the bladeless ceiling fan 155 through the inlet 180. The impeller 190 may propel and direct the air through the conduits 170 to the annular nozzle 165. The nozzle 165 may define a channel 193 that receives the air from the central hub 160. The nozzle 165 may also define an outlet 195 in communication with the channel 193 by which the air may be directed out of the bladeless ceiling fan 155. In some embodiments, the outlet 195 may be defined on an inner diameter of the nozzle 165 as shown in FIGS. 1B and 1C. The outlet 195 may be defined by a gap between two walls of the nozzle 165.

The following explanations in regards to the ceiling fan 105 (e.g., the components of the ceiling fan 105), and the methods of controlling the ceiling fan 105, similarly apply to the bladeless ceiling fan 155. As described herein, various outputs, states, functions, parameters, and/or the like, of the ceiling fan 150 and/or the bladeless ceiling fan 155 may be controlled by way of the remote device 110. Additionally, or alternatively, aspects of the motor 185, the impeller 190, and/or other fan components (e.g., the fan blades, the fan modules, the fan locking mechanisms, and/or the like) may be controlled by way of the remote device 110 as described herein. In this way, the remote device 110 may obviate the need to manually access hard-to-reach mechanical controls typically located on the hub of the ceiling fan 105 and/or the hub of the bladeless ceiling fan 155. In this way, elderly users, users with physical disabilities or handicaps, and/or the like are afforded opportunities to access and/or control the ceiling fan 105 and/or the bladeless ceiling fan 155 as such controls may otherwise be inaccessible to such users, for example, by virtue of being disposed proximate the ceiling, where the hub of the ceiling fan may be located. Further, in this way, the efficiency and/or speed at which a ceiling fan may be controlled and/or caused to implement controls may improve.

In some embodiments, the ceiling fan 105 (or the bladeless ceiling fan 155) may additionally include a wireless transceiver 135 (FIG. 1A) by which the ceiling fan 105 and the remote device 110 may wirelessly communicate by way of the communications network 112 (FIG. 1A). In some embodiments, the wireless transceiver 135 may be configured to bidirectionally communicate with the remote device 110 over a wireless link 140 and via a corresponding wireless transceiver 145 of the remote device 110. Communication between the ceiling fan 105 and the remote device 110 may occur over the wireless link 140 according to a wireless technology or protocol, such as by way of a Bluetooth® Low Energy signal (e.g., iBeacon), a WiFi protocol, a Zigbee protocol, Z-wave technology, a cellular network protocol (e.g., 3G, 4G, 5G, and/or the like), mesh network technology, a radio signal, an infrared signal, and/or the like. For example, the wireless transceiver 135 of the ceiling fan 105 and the wireless transceiver 145 of the remote device 110 may include one or more transceiver circuits that allow for transmission and reception of radio signals between the ceiling fan 105 and the remote device 110.

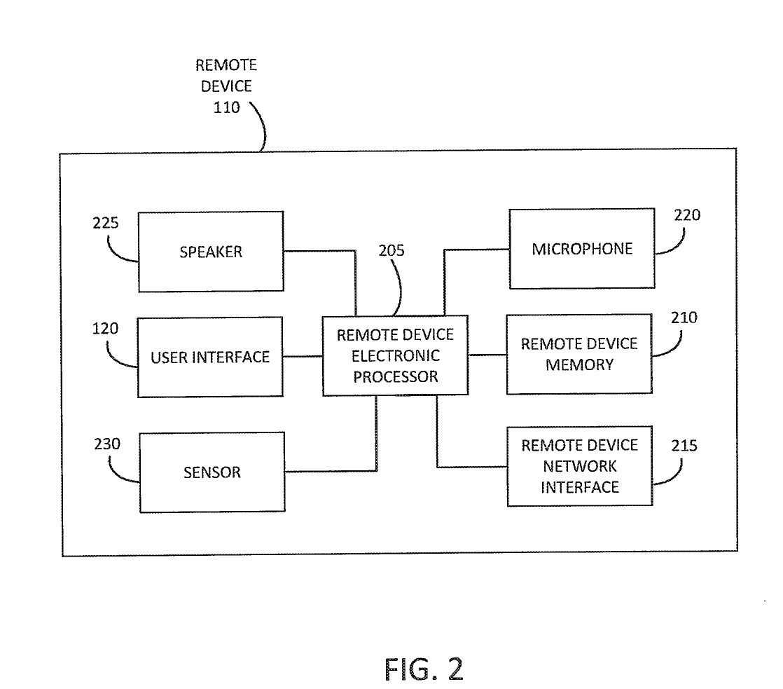

FIG. 2 is a block diagram of the remote device 110 according to one example embodiment. In the embodiment illustrated, the remote device 110 may include one or more components such as a remote device electronic processor 205. The remote device electronic processor 205 may include input and output interfaces (not shown) and may be electrically coupled to a remote device memory 210, a remote device network interface 215, a microphone 220, a speaker 225, the user interface 120, and/or a temperature sensor 230. In some embodiments, the remote device 110 may include more or less than one of the components shown in FIG. 2.

The remote device electronic processor 205 is implemented in hardware, firmware, or a combination of hardware and software. The remote device electronic processor 205 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some embodiments, the remote device electronic processor 205 includes one or more processors capable of being programmed to perform a function automatically, or based on a user input. Such function may include instructing or controlling the ceiling fan 105, instructing or controlling the bladeless ceiling fan 155, and/or instructing or controlling components of the ceiling fan 105 and/or the bladeless ceiling fan 155. In this way, the ceiling fan 105 and/or the bladeless ceiling fan 155 may be caused to perform one or more actions (e.g., power on, power off, adjust a blade angle, lock the blades, unlock the blades, increase a rotational speed, decrease a rotational speed, dispense a scent, dispense bug repellant, employ a battery backup for powering the components in FIG. 2, play music, and/or the like) based on such instruction and/or control provided by remote device 110.

In some embodiments, the ceiling fan 105 and/or the bladeless ceiling fan 155 may be caused to perform one or more actions based on receiving a user input (e.g., a user interacting with the remote device 110). In other embodiments, the ceiling fan 105 and/or the bladeless ceiling fan 155 may be caused to perform one or more actions, automatically, based on the remote device electronic processor 205 determining that one or more events has occurred by way of receiving input from the sensor 230. For example, remote device electronic processor 205 may determine that the ceiling fan has been impacted by an object based on input (e.g., signals, and/or the like) received from an impact sensor (e.g., an accelerometer, and/or the like) and automatically lock the fan blades. In another example, the remote device electronic processor 205 may automatically turn the ceiling fan on/off and/or increase/decrease a rotational speed of the ceiling fan blades based on input received from a temperature sensor (e.g., employing a thermistor, resistance-based sensor, thermocouple, and/or the like). In this way, the remote device 110 may receive and process various inputs and intelligently control the ceiling fan 105 by way of causing the ceiling fan 105 to implement tasks based on the inputs.

The remote device memory 210 stores information and/or software related to the operation and use of the remote device 110. The remote device memory 210 may include read only memory (ROM), random access memory (RAM), a hard disk (e.g., a magnetic disk, and optical disk, and/or the like), a cartridge, magnetic tape, and/or another type of non-transitory computer-readable media, or a combination thereof. The remote device electronic processor 205 may be configured to receive instructions and/or data from the remote device memory 210 and execute, among other things, the instructions. For example, the remote device electronic processor 205 may execute an “app” (i.e., a software application) or another program. In particular, the remote device electronic processor 205 may execute instructions stored in the remote device memory 210 to perform any of the methods described herein.

The remote device network interface 215 includes a transceiver-like component (e.g., the wireless transceiver 145 and/or a separate receiver and transmitter) that enables remote device 210 to communicate with other devices (e.g., the ceiling fan 105, a smartphone, a computer, and/or the like), such as via a wired connection, a wireless connection, or a combination of wired and wireless connections. The remote device network interface 215 may send and receive data to and from the ceiling fan 105, to and from the bladeless ceiling fan 155, and/or the like, by way of the network 112 (FIG. 1A). The remote device network interface 215 may permit the remote device 110 to receive information from another device and/or provide information to another device. For example, the remote device network interface 215 may include an Ethernet interface, an optical interface, a coaxial interface, an infrared interface, a radio frequency (RF) interface, a universal serial bus (USB) interface, a Wi-Fi interface, a cellular network interface, or the like.

The remote device electronic processor 205 may receive electrical signals representing sound from the microphone 220 and may communicate information relating to the electrical signals over the network 112 (FIG. 1A) by way of the remote device network interface 215 to other devices, for example, to one or more smartphones, the ceiling fan 105, and/or the like. The remote device electronic processor 205 may cause the speaker 225 to output sound and may cause the user interface 120 to display information (e.g., an audible or visible alert to a user) based on the electrical signals received from the microphone 220.

The user interface 120 displays images, graphics, video, text, interactive user elements (e.g., links to websites, dropdown boxes, text boxes, and/or the like), and/or data to the user. The user interface 120 may be a liquid crystal display (LCD) screen or an organic light emitting display (OLED) display screen. In some embodiments, a touch sensitive input interface may be incorporated into the user interface 120 as well, allowing the user to interact with content provided on the user interface 120 (e.g., a touchscreen). In some embodiments, the speaker 225 and the user interface 120 are referred to as output devices that present information to the user of the remote device 110. In some embodiments, the user interface 120, the microphone 220, a computer mouse, and/or a keyboard or other input buttons are referred to as input devices that receive input from the user of the remote device 110.

In some embodiments, the sensor 230 may include a temperature sensor be disposed on the remote device electronic processor 205 for providing an electrical signal indicative of a temperature of a space in which the remote device 110 is located. The remote device electronic processor 205 may obtain the electrical signal and determine the temperature of the space based on processing the electrical signal from the sensor 230 and may use the determined temperature to provide instructions to control the ceiling fan 105 as described in greater detail below. In some embodiments, the sensor 230 may include a humidity sensor, an optical/light sensor (for use in determining whether to power the ceiling fan 105 on/off in response to detecting light/dark), occupancy sensors (e.g., motion sensors), image sensors, and/or the like.

The remote device 110 may perform one or more methods described herein. The remote device 110 may perform these methods based on the remote device electronic processor 205 executing software instructions stored by a non-transitory computer-readable medium, such as remote device memory 210 and/or other storage component. A computer-readable medium is defined herein as a non-transitory memory device. A memory device includes memory space within a single physical storage device or memory space spread across multiple physical storage devices.

Software instructions may be read into remote device memory 210 from another computer-readable medium or from another device via remote device network interface 215 or other interface. When executed, the software instructions stored in the remote device memory 210 may cause remote device processor 205 to perform one or more methods described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In practice, remote device 110 may include additional components, fewer components, different components, or differently arranged components than those shown in FIG. 2. For example, the remote device 110 may additionally include a camera and/or one or more additional input devices such as a computer mouse and/or a keyboard that receive inputs from the user of the remote device 110. As another example, although not shown in FIG. 2, the remote device 110 may include a power supply (e.g., a battery) configured to provide power to the electronic elements of the remote device 110. As yet another example, the remote device 110 may not include the sensor 230 or the remote device may include multiple types of sensors (e.g., optical sensors, motion detecting sensors, and/or the like). In some cases, a separate sensor (e.g., sensor devices 147 shown in FIG. 1A) may be included in a room in which the ceiling fan 105 is located, and the separate sensor may be configured to communicate obtained inputs (e.g., temperature readings, and/or the like) to the remote device 110 and/or the ceiling fan 105 over the network 112 as indicated by the wireless links 140 in FIG. 1A. In some embodiments, the remote device 110 performs functionality other than the functionality described herein. Additionally, or alternatively, a set of components (e.g., one or more components) of remote device 110 may perform one or more functions described as being performed by another set of components of remote device 110.

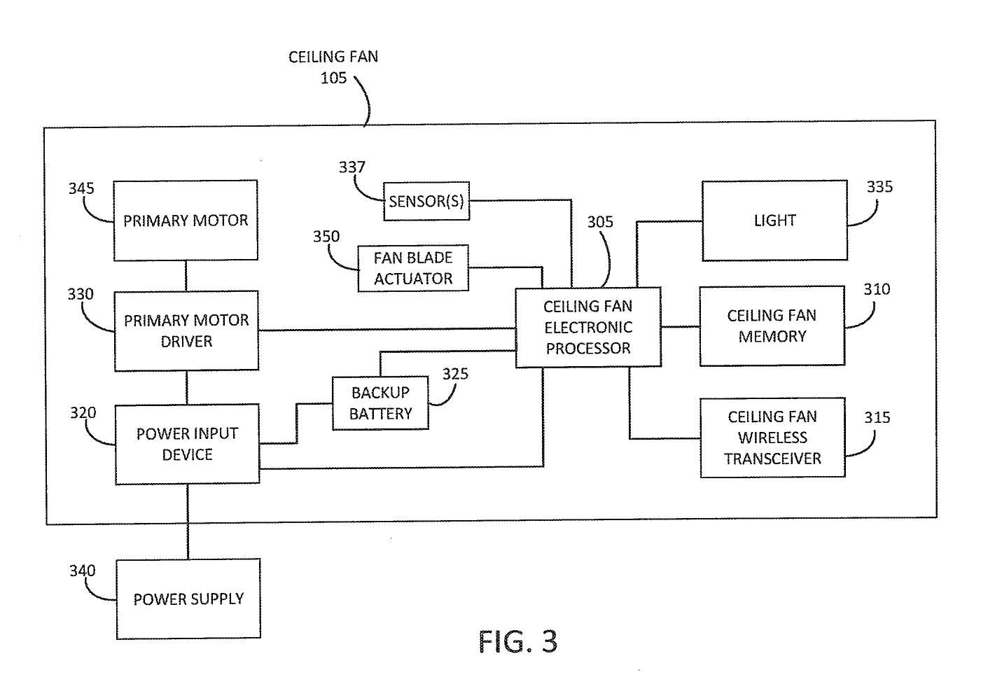

FIG. 3 is a block diagram of the ceiling fan 105 according to one example embodiment. In the embodiment illustrated, the ceiling fan 105 may include one or more components such as a ceiling fan electronic processor 305 communicatively coupled to a ceiling fan memory 310 and a ceiling fan wireless transceiver 315. The ceiling fan electronic processor 305, the ceiling fan memory 310, and the ceiling fan wireless transceiver 315 may be respectively similar to the remote device electronic processor 205, the remote device memory 210, and the remote device network interface 215 of the remote device 110 described above with respect to FIG. 2 and the previous description thereof respectively applies to these elements of the ceiling fan 105. As shown in FIG. 3, the ceiling fan electronic processor 305 may be communicatively coupled (e.g., electrically coupled) to a power input device 320, a backup battery 325, a primary motor driver 330, a light 335, and/or one or more sensors 337. Consistent with the description above, the ceiling fan 105 and/or the bladeless ceiling fan 155 may be caused to perform one or more actions based on receiving a direct user input or an indirect user input, for example, by way of the remote device 110. The ceiling fan 105 and/or the bladeless ceiling fan 155 may additionally be caused to perform one or more actions based on the ceiling fan electronic processor 305 determining that one or more events has occurred by way of receiving input from the sensor 337. For example, the ceiling fan electronic processor 305 may determine that the ceiling fan 105 has been impacted by an object based on input received from an impact sensor (e.g., an accelerometer) and automatically lock the fan blades. Similarly, the ceiling fan electronic processor 305 may determine that the temperature of a space in which the ceiling fan 105 is located satisfies a threshold based on a reading from a temperature sensor, and automatically power on, off, and/or adjust a speed of rotation based on such reading.

In some embodiments, the power input device 320 may receive power from a power supply 340 such as a mains alternating-current (AC) power supply, for example, of a building. The power input device 320 may provide power from the power supply 340 to the electronic components of the ceiling fan 105, such as the components shown in FIG. 3. For example, the power input device 320 may include combinations of active and passive components (e.g., voltage step-down controllers, voltage converters, rectifiers, filters, etc.) to regulate or control the power received from the power supply 340 provided to the components of the ceiling fan 105. Although FIG. 3 does not show connections between the power input device 320 and some other components of the ceiling fan 105, such connections may nevertheless be present in some embodiments. For example, the power input device 320 may be connected to the ceiling fan wireless transceiver 315 and/or the light 335.

In some embodiments, the ceiling fan electronic processor 305 may detect a loss of power from the power supply 340 (e.g., a power outage of the mains AC power supply). For example, the ceiling fan electronic processor 305 and/or the power input device 320 may include circuitry to detect when a power outage of the mains AC power supply occurs as opposed to a situation where power is no longer being provided to the ceiling fan 105 when the ceiling fan 105 is turned off by a user. As explained in greater detail below, to allow the ceiling fan 105 to continue to operate when power from the power supply 340 is not available, the ceiling fan 105 may employ the backup battery 325. The backup battery 325 may be a rechargeable battery, such as a Li-ion battery, and may be coupled to the power input device 320 to provide power to the components of the ceiling fan 105 in the event of a power loss or outage. In this way, the ceiling fan 105 may be operable to provide light and/or generate airflow during such an event. In this way, the backup battery 325 may be charged using energy received from the power supply 340 during normal operation and such energy may be discharged during losses in power received from the power supply 340.

The primary motor driver 330 may enable the ceiling fan electronic processor 305 to control operation of a primary motor 345 of the ceiling fan 105. The primary motor 345 may be positioned within the hub 125 and configured to rotate the plurality of fan blades 130 to create an airflow in the room or area in which the ceiling fan 105 is located. Through the primary motor driver 330, the ceiling fan electronic processor 305 may control an electrical current (e.g., the flow of electrical current, the amount of electrical current, and/or the like) being supplied from the power input device 320 to the primary motor 345 to rotate the primary motor 345 according to one or more instructions received from remote device 110 (FIG. 2) and/or according to one or more programs executed by the ceiling fan electronic processor 305. In this way, the processor 305 may receive, implement, and/or execute the one or more instructions and/or programs and cause the primary motor 345 to induce rotation of the fan blades 130, stop rotation of the fan blades 130, increase/decrease a speed of rotation of the fan blades 130, alter a rotational direction of the fan blades 130 and/or the like. For example, the primary motor driver 330 may include several field effect transistors (FETs), bipolar transistors, or other types of electrical switches, such as six FETs in a bridge arrangement. The ceiling fan electronic processor 305 may drive successive switching elements of the primary motor driver 330 with respective pulse width modulation (PWM) signals to alternately drive stator coils of a stator of the primary motor 345, thus inducing rotation of a rotor of the primary motor 345 to cause the plurality of fan blades 130 to rotate around the hub 125 (or to cause the hub 125 or a portion of the hub 125 to rotate).

As shown in FIG. 3, the ceiling fan 105 may include a light 335. The light 335 may include one or more light emitting diodes (LEDs) or other light-emitting elements. In some embodiments, the LEDs may be color changing LEDs, dimmable LEDs, and/or the like. The light 335 may be located in, on, over and/or around the hub 125 (e.g., on and/or proximate to a bottom surface of the hub 125) and may provide light to the room or area in which the ceiling fan 105 is located. In other embodiments, the light 335 may be located elsewhere on the ceiling fan 105.

In some embodiments, the ceiling fan 105 may include fewer or additional components in configurations different from that illustrated in FIG. 3. For example, the ceiling fan 105 may include a camera, such as a security camera or baby monitor. In embodiments that include the camera, the ceiling fan 105 may send information to the remote device 110 via the ceiling fan wireless transceiver 315, such as streaming video or still images. The video and/or images may be displayed on the remote device 110, in some embodiments. Additionally, or alternatively, in embodiments where the camera is a security camera, the ceiling fan electronic processor 305 may initiate security protocols (e.g., flash the light 335, sound an alarm through a speaker of the ceiling fan 105, and/or the like) in response to the security camera detecting motion. Such security protocols may be initiated by the ceiling fan electronic processor 305 in response to the security camera detecting motion (e.g., via an infrared sensor, a vibration detecting sensor, an ultrasonic sensor, and/or the like) or may be initiated by a user via an instruction from the remote device 110 after the user verifies that the motion detected by the security camera is a security threat (e.g., an intruder). Continuing this example, the remote device 110 may also receive movement thresholds from the user via the remote device 110 that determine how much movement should be detected for the ceiling fan electronic processor 305 to initiate the security protocols.

As another example of the ceiling fan 105 including fewer or additional components than those shown in FIG. 3, the ceiling fan 105 may include a speaker, such as a wireless Bluetooth speaker. In such embodiments, a user may control the ceiling fan 105 and cause the fan 105 to play music, stream audio data, or emit other sounds through the speaker using the remote device 110. Additionally, the speaker may be used to sound an alarm as described above with respect to the security camera example.

In some embodiments, the ceiling fan 105 additionally includes at least one fan blade actuator 350 controllable by the ceiling fan electronic processor 305 to adjust an orientation of the fan blades 130 (e.g., to adjust the pitch angle of the fan blades 130). The fan blade actuator 350 may include a secondary motor, a drive chain, a gear assembly, a pulley, and/or the like. In this way, a pitch angle of the fan blades 130 may be adjusted (e.g., individually or simultaneously) to achieve desired airflow effects (e.g., more downwardly-directed airflow, more horizontally-directed airflow, etc.) during use. In this way, the airflows generated by way of ceiling fan 105 may be adjusted, optimized, and/or customized according to the user's preference.

In some embodiments, the ceiling fan 105 sensors 337 may include an air quality monitor, such as a smoke detector (e.g., a photoelectric smoke detector, an ionization smoke detector, and/or the like), a carbon monoxide detector (e.g., an opto-chemical carbon monoxide detector, an biomimetic carbon monoxide detector, and/or the like), and/or the like. In such embodiments, the ceiling fan 105 may send an alert or notification via the ceiling fan wireless transceiver 315 to the remote device 110 in response to a hazardous condition being detected by the sensor 337.

In some embodiments, the sensor 337 of the ceiling fan 105 may include a temperature sensor. In this way, the ceiling fan 105 may be controlled based on changes in temperature. For example, the ceiling fan 105 may be caused to power on (or increase fan blade rotational speeds) when the temperature sensor detects a temperature satisfying a first threshold (e.g., the temperature exceeds a first temperature threshold). Similarly, the ceiling fan 105 may be caused to power off (or decrease fan blade rotational speeds) when the temperature sensor detects a temperature satisfying a second threshold (e.g., the temperature is less than a second temperature threshold). Other temperature induced actions are contemplated.

In some embodiments, the sensor 337 of the ceiling fan 105 may include a humidity sensor (e.g., employing a capacitive sensor, a resistive sensor, and/or the like). In this way, the ceiling fan 105 may be controlled based on changes in humidity. For example, the ceiling fan 105 may be caused to turn on when the humidity sensor detects a humidity level satisfying a first threshold (e.g., the humidity level exceeds a first humidity threshold). Similarly, the ceiling fan 105 may be caused to turn off when the humidity sensor detects a humidity level satisfying a second threshold (e.g., the humidity is less than a second humidity threshold). Other humidity induced actions are contemplated.

In some embodiments, the sensor 337 of the ceiling fan 105 may include an optical sensor (e.g., employing a photoconductive device, a photodiode, a photovoltaic cell, an ambient light sensor, and/or the like). In this way, the ceiling fan 105 may be controlled based on changes in an amount or level of light. For example, the ceiling fan 105 may be caused to turn off (or on) when the level of light satisfies a first threshold (e.g., the ceiling fan 105 may be caused to turn off (or on) based on detecting morning light). Similarly, the ceiling fan 105 may be caused to turn on (or off) when the level of light satisfies a second threshold (e.g., the ceiling fan 105 may be caused to turn on (or off) based on detecting nightfall). Other light included actions are contemplated.

In some embodiments, the sensor 337 of the ceiling fan 105 may include an occupancy sensor (e.g., employing a passive infrared sensor, an ultrasonic sensor, a smart meter, facial recognition technology, a sensor communicatively coupled to a door operated switch, an audio sensor, and/or the like). In this way, the ceiling fan 105 may be controlled based on changes in an amount or level of occupancy of a room. For example, the ceiling fan 105 may be caused to turn off (or on) when the occupancy level satisfies a threshold. For example, the ceiling fan 105 may turn off when the occupancy of a room is low or zero (e.g., devoid of occupants). Similarly, the ceiling fan 105 may turn on when the occupancy of a room is high or non-zero. Other occupancy induced actions are contemplated.

In some embodiments, the ceiling fan 105 may include a real-time clock to keep track of time. For example, the real-time clock may be included in the ceiling fan electronic processor 305. In some embodiments, the ceiling fan 105 may not include the light 335 and/or the backup battery 325. In some embodiments, the ceiling fan 105 may perform functionality other than the functionality described herein.

The ceiling fan 105 may perform one or more methods described herein. The ceiling fan 105 may perform these methods based on the ceiling fan electronic processor 305 executing software instructions stored by a non-transitory computer-readable medium, such as ceiling fan memory 310 and/or other storage component. Software instructions may be read into the ceiling fan 105 from another computer-readable medium or from another device via remote device ceiling fan wireless transceiver 315 or other interface. When executed, the software instructions stored in the ceiling fan 105 may cause remote ceiling fan 105 to perform one or more methods described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 3 are provided as an example. In practice, the ceiling fan 105 may include additional components, fewer components, different components, or differently arranged components than those shown in FIG. 3. In some embodiments, the ceiling fan 105 performs functionality other than the functionality described herein. Additionally, or alternatively, a set of components (e.g., one or more components in FIG. 2) of the ceiling fan 105 may perform one or more functions described as being performed by another set of components of the ceiling fan 105.

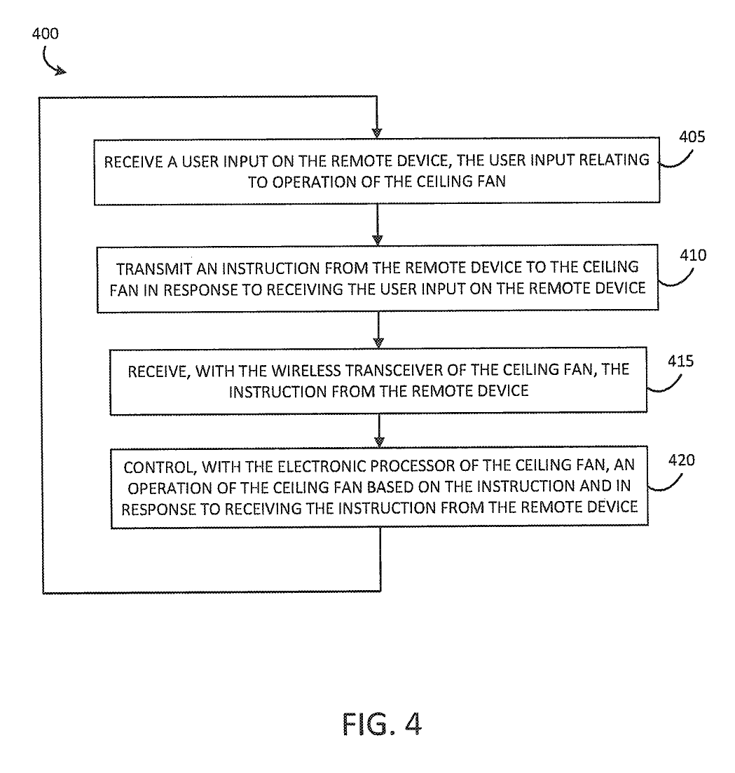

FIG. 4 is a flow chart of an example process for controlling a ceiling fan. In some embodiments, one or more process blocks of FIG. 4 may be performed by the remote device 110 or components of the remote device 110 (e.g., the remote device electronic processor 210, the remote device memory 210, the remote device network interface 215, the microphone 220, the speaker 225, the user interface 120, or the sensor 230). In some embodiments, one or more process blocks of FIG. 4 may be performed by another device or a group of devices separate from the remote device 110, such the ceiling fan 105 or components of the ceiling fan (e.g., the ceiling fan electronic processor 305, the ceiling fan memory 310, the ceiling fan wireless transceiver 315, the light 335, the backup battery 325, the power supply 340, the power input device 320, the primary motor driver 330, or the primary motor 345).

In some embodiments, a user may interact with the remote device 110 to control the ceiling fan 105. At block 405, the remote device electronic processor 215 of the remote device 110 may receive a user input relating to operation of the ceiling fan 105 by way of the user interacting with the user interface 120. For example, the user interface 120 may display a screen that includes operational states or parameters of the ceiling fan 105 such as whether the primary motor 345 is on or off, a speed of the primary motor 345, whether the light 335 is on or off, and/or the like. The user may provide the user input to change one or more operating parameters of the ceiling fan 105. Such user input may be received by the remote device electronic processer 205, which generates one or more instructions for implementation by the ceiling fan 105.

At block 410, the remote device electronic processor 205 may transmit the one or more instructions from the remote device 110 to the ceiling fan 105, via the remote device network interface 215, in response to receiving the user input on the remote device 110 and generating the one or more instructions. At block 415, the ceiling fan 105 may receive the instruction from the remote device 110 via the ceiling fan wireless transceiver 315. At block 420, the ceiling fan electronic processor 305 may control an operation of the ceiling fan 105 based on the instruction and in response to receiving the instruction from the remote device 110. The operation controlled by the instruction may include turning the primary motor 345 on and/or off, changing the rotation speed of the primary motor 345, setting a rotation direction of the primary motor 345, turning the light 335 of the ceiling fan 105 on and/or off, setting a brightness and/or color of the light 335, dispensing scented spray and/or bug repellant, locking the fan blades, unlocking the fan blades, tilting the fan blades, and/or the like. Controlling the operation of the ceiling fan 105 using the remote device 110 may be beneficial as the ceiling fan 105 may be caused to perform actions without the need for manually actuating a device on the ceiling fan (e.g., pulling a pull chain, flipping a switch, and/or the like) or without being in the same room as the ceiling fan 105.

In some embodiments, the instruction received by the ceiling fan 105 from the remote device 110 may set an alarm (e.g., a user wakeup alarm) for the ceiling fan 105. For example, the instruction may specify a time and/or day for the alarm. The alarm may be set as a one-time alarm or as a recurring alarm. The ceiling fan electronic processor 305 and/or the remote device processor 205 may store specified alarm times and days in the ceiling fan memory 310 and/or the remote device memory 210 for comparison to a current time and day as determined, for example, by a real-time clock included in the ceiling fan 105 and/or the remote device 110. When the ceiling fan electronic processor 305 and/or the remote device processor 205 determines that the current time and/or day matches the stored specified alarm time and/or day, the ceiling fan electronic processor 305 may be configured and/or instructed to control the ceiling fan 105 in accordance with a user-selected operation of the ceiling fan 105 (e.g., stop rotating the primary motor 345, turn on the light 335, and/or the like) thereby encouraging the user to wake up.

Similarly, in some embodiments, the instruction received by the ceiling fan 105 from the remote device 110 may include a schedule of operation times and/or dates of the ceiling fan 105. For example, the remote device 110 may receive, via the user interface 120, user-selected operation times and/or dates during which components of the ceiling fan 105 are to operate or not operate. The ceiling fan electronic processor 305 and/or the remote device processor 205 may store the operation times and/or dates in the ceiling fan memory 310 and/or the remote device memory 210 for comparison to a current time and day as determined by the real-time clock included in the ceiling fan 105 and/or a real-time clock accessibly by the remote device 110. The ceiling fan electronic processor 305 and/or the remote device processor 205 may control the components of the ceiling fan 105 in accordance with the operation times and/or dates. For example, the ceiling fan electronic processor 305 and/or the remote device processor 205 may turn on/off the primary motor 345 and/or the light 335 based on the scheduled operation times and/or dates. In other words, the remote device 110 may be used to set desired runtimes for the ceiling fan 105. As another example, the ceiling fan electronic processor 305 may be caused to dispense scented spray, bug repellant, and/or the like based on the scheduled operation times and/or dates. As yet another example, the ceiling fan electronic processor 305 may control the primary motor 345 to change speed or direction of rotation based on the scheduled operation times and/or dates. In other words, the ceiling fan electronic processor 305 may be configured to control the ceiling fan 105 to function differently at different operation times included in a schedule of operation times, which may be beneficial to maintain a relatively constant temperature of a room as the outside temperature and/or an amount of sunlight disposed in the room change over the course of a day. For example, the ceiling fan electronic processor 305 may be configured to control the ceiling fan 105 to rotate differently at different operation times included in a schedule of operation times (e.g., rotate at different speeds, rotate in different directions, prevent rotation, etc.).

In some embodiments, the ceiling fan electronic processor 305 may be configured to store usage patterns of the ceiling fan 105 and control operation of the ceiling fan 105 based on the stored usage patterns. For example, the ceiling fan electronic processor 305 may recognize that an instruction to turn on the primary motor 345 has been received from the remote device 110 at 5:00 PM for multiple days (e.g., five consecutive days). Accordingly, on a next day (e.g., the sixth consecutive day), the ceiling fan electronic processor 305 may automatically turn on the primary motor 345 at 5:00 PM without receiving an instruction to do so from the remote device 110. As another example, the ceiling fan electronic processor 305 may recognize that an instruction to turn on the primary motor 345 has been received from the remote device 110 each time a monitored temperature of the room in which the ceiling fan 105 is located satisfies a threshold (e.g., each time the temperature of the room exceeds 75° F.). Accordingly, the ceiling fan electronic processor 305 may turn on the primary motor 345 the next time the temperature in the room satisfies the threshold (for example, as determined by an integrated temperature sensor or a separate, discrete temperature sensor) without receiving an instruction to do so from the remote device 110. In some situations, controlling operation of the ceiling fan 105 based on stored usage patterns may allow for improved airflow in the room where the ceiling fan 105 is located when the user is not present or when the user forgets to control operation of the ceiling fan 105.

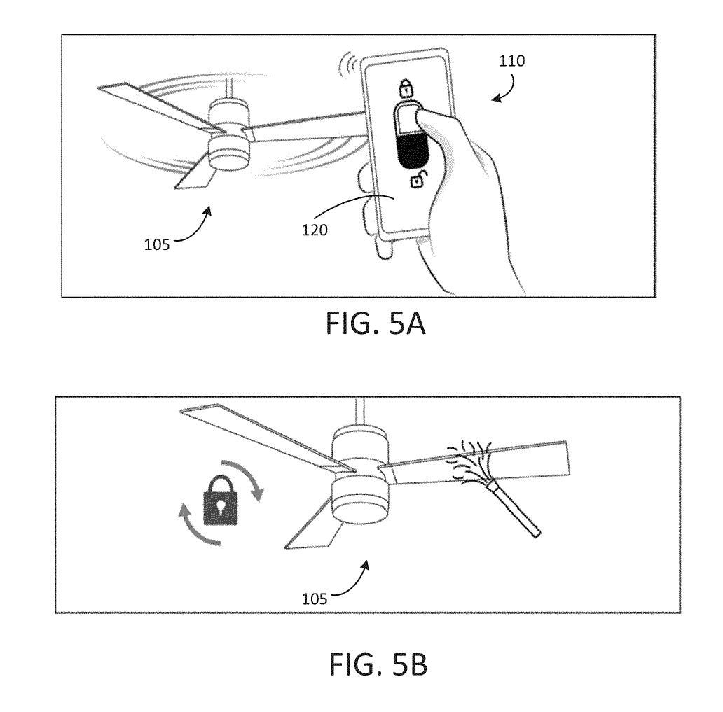

In some embodiments, the instruction received by the ceiling fan 105 from the remote device 110 may activate or deactivate a lock mechanism and, thus, employ a blade lock control for the primary motor 345 as shown in FIGS. 5A-5B. The lock mechanism may be operable to selectively inhibit rotation of the primary motor 345 and the plurality of fan blades 130 relative to the hub 125. In some embodiments, the lock mechanism may actuate a brake mechanism on the primary motor 345 to inhibit the primary motor 345 and therefore the plurality of fan blades 130 from rotating around the hub 125. In other embodiments, the lock mechanism may provide a physical stop that inhibits two pieces of the hub 125 from moving relative to each other. When the lock mechanism is engaged, as shown in FIG. 5B, the fan blades 130 can be, for example, more easily dusted without unintentionally moving away from a user. As shown in FIG. 5A, the remote device 110 may be used to receive a lock command from the user via the user interface 120 of the remote device 110 and transmit the lock command to the ceiling fan 105. In response to receiving the lock command, the ceiling fan electronic processor 305 may be configured to inhibit rotation of the plurality of fan blades 130. Similarly, in response to receiving an unlock command from the remote device 110 generated based on a user input via the user interface 120, the ceiling fan electronic processor 305 may be configured to unlock, and cause or allow rotation of the plurality of fan blades 130.

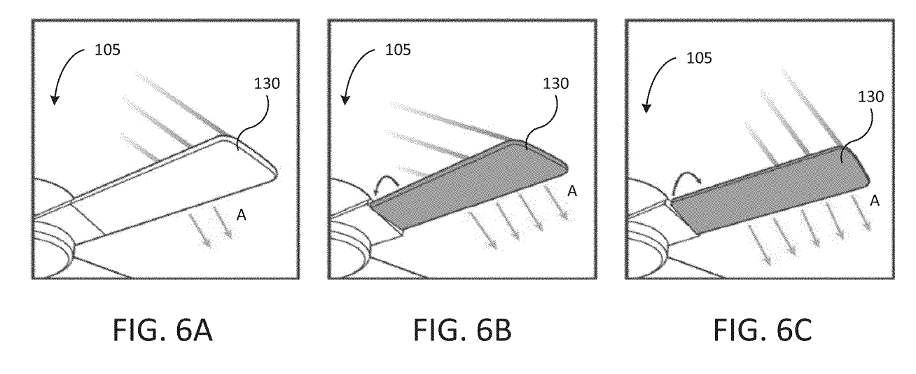

In some embodiments, the instruction received by the ceiling fan 105 from the remote device 110 may instruct the ceiling fan electronic processor 305 to adjust an orientation of the fan blades 130 and, thus, employ a fan blade pitch angle control as shown in FIGS. 6A-6C. For example, a pitch angle of the fan blades 130 may be adjusted to achieve desired airflow effects (e.g., more downwardly-directed airflow, more horizontally-directed airflow, etc.). In response to receiving a pitch angle command from the remote device 110, the ceiling fan electronic processor 305 may be configured to control the secondary motor of the ceiling fan 105 to adjust the pitch angle of the plurality of fan blades 130. The pitch angle command generated by the remote device 110 based on a user input may indicate an absolute value of a desired pitch angle (e.g., an angle between +/−5 degrees, an angle between +/−15 degrees, an angle between +/−45 degrees, etc.) and/or a desired value by which to increase or decrease a current pitch angle of the plurality of fan blades 130 (e.g., on a sliding scale). FIGS. 6A-6C illustrate the ceiling fan 105 with the fan blades 130 at various pitch angles. For example, FIG. 6A shows the fan blades 130 having about a zero-degree pitch angle. FIG. 6B shows the fan blades 130 with a slight pitch angle upward in the direction of rotation. FIG. 6C shows the fan blades 130 with a slight pitch angle downward in the direction of rotation. In FIGS. 6A-6C, the direction of rotation of the fan blades 130 is indicated by arrows A.

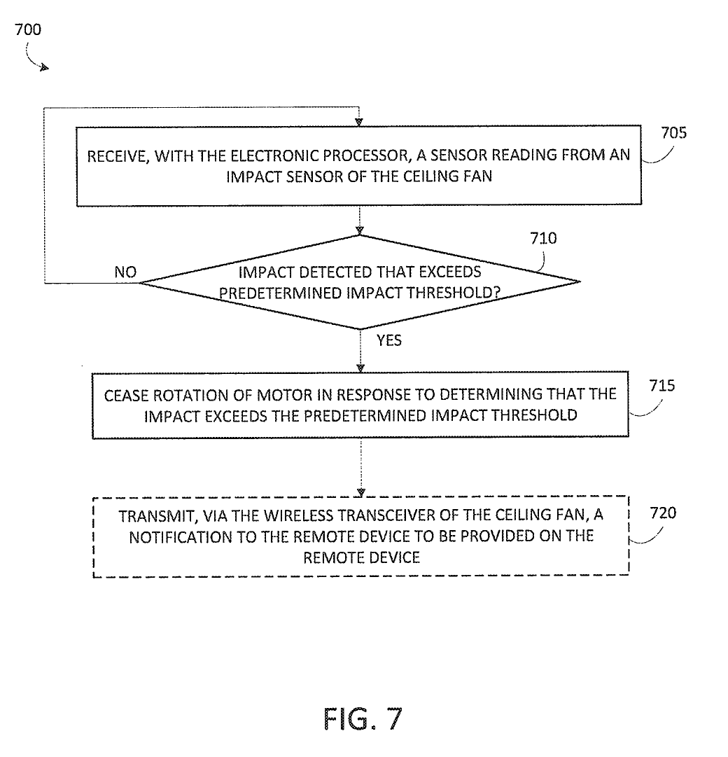

FIGS. 7-11 are flow charts of an example processes for controlling a ceiling fan. In some embodiments, one or more process blocks of FIGS. 7-11 may be performed by the remote device 110 or components of the remote device 110 (e.g., the remote device electronic processor 210, the remote device memory 210, the remote device network interface 215, the microphone 220, the speaker 225, the user interface 120, or the sensor 230). In some embodiments, one or more process blocks of FIGS. 7-11 may be performed by another device or a group of devices separate from the remote device 110, such the ceiling fan 105 or components of the ceiling fan (e.g., the ceiling fan electronic processor 305, the ceiling fan memory 310, the ceiling fan wireless transceiver 315, the light 335, the backup battery 325, the power supply 340, the power input device 320, the primary motor driver 330, or the primary motor 345).

In some embodiments, the ceiling fan 105 may include an impact sensor disposed thereon and electrically coupled to the ceiling fan electronic processor 305 to allow the ceiling fan electronic processor 305 to detect impacts experienced by the plurality of fan blades 130. Referring to FIG. 7, and at block 705, the ceiling fan electronic processor 305 may receive input from the impact sensor (e.g., the ceiling fan electronic processor 305 may receive a sensor reading from the impact sensor). In some embodiments, the input is indicative of an impact being imparted to fan blade or other fan component (e.g., the hub, the light, and/or the like).

At block 710, the ceiling fan electronic processor 305 may determine whether the sensor reading indicates that an impact satisfying a predetermined impact threshold has been experienced by the fan, or a portion thereof (e.g., the fan blades 130). When the detected impact does not satisfy the predetermined impact threshold, the method 700 may proceed back to block 705 for continued monitoring of sensor readings from the impact sensor. When the detected impact satisfies the predetermined impact threshold, at block 715, the ceiling fan electronic processor 305 may cease rotation of the primary motor 345 to cease rotation of the plurality of fan blades 130 based on, for example, the ceiling fan electronic processor 305 determining that the impact exceeds the predetermined threshold. In some embodiments, the predetermined impact threshold may be set by the user via the remote device 110 and be transmitted to the ceiling fan 105. In other words, the sensitivity of impact detection shutdown may be adjusted by the user via the remote device 110. As indicated in dashed lines at block 720 of FIG. 7, in some embodiments, the ceiling fan electronic processor 305 may transmit a notification to the remote device 110 in response to determining that the detected impact satisfies the predetermined threshold. The remote device 110 may audibly or visually provide the notification to the user to indicate that an impact of the fan blades 130 has been detected. If desired, the user may then select the lock command on the remote device 110 to stop and/or inhibit the primary motor 345 and the fan blades 130 from rotating and/or the user may select an unlock command to permit rotation of the primary motor 345 when it is determined that the impact has been mitigated. In this way, the ceiling fan and/or the fan blades of the ceiling fan may experience reduced damage upon being impacted by an object.

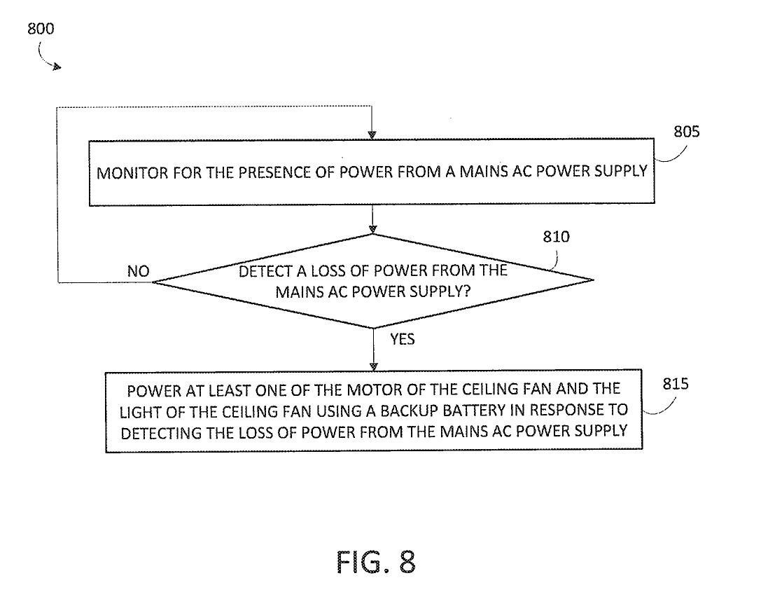

FIG. 8 is a flowchart of a method 800 of employing a backup battery control by way of discharging energy from the backup battery 325 during outages or loss of a mains power source. At block 805, the ceiling fan electronic processor 305 may monitor and/or periodically detect the presence of power from a mains AC power supply (i.e., the power supply 340). At block 810, the ceiling fan electronic processor 305 may determine whether a loss of power from mains AC power supply has occurred. When no such power loss has occurred, the method 800 may proceed back to block 805. When the ceiling fan electronic processor 305 detects a loss of power from the mains AC power supply, at block 815, the ceiling fan electronic processor 305 may power at least one of the primary motor 345 and the light 335 using the backup battery 325 in response to detecting the loss of power from the mains AC power supply. For example, the ceiling fan electronic processor 305 may control one or more switches inside the power input device 320 to allow power from the backup battery 325 to be transferred to the at least one of the primary motor 345 and the light 335. In some embodiments, the settings associated with the method 800 involving the backup battery 325 may be set by the user via the remote device 110 and transmitted to the ceiling fan 105. For example, using the remote device 110, a user may select how long a power outage should be detected before the backup battery 325 is used to power the ceiling fan 105 (e.g., more than 1 minute, more than 10 minutes, more than 1 hour, etc.). As another example, the user may select whether the light 335, the primary motor 345, or both should be caused to turn on in response to detection of a power outage. Additionally, the user may monitor a status of the backup battery 325 (e.g., the charge level of the backup battery 325), test the backup battery 325, and/or the like, using the remote device 110.

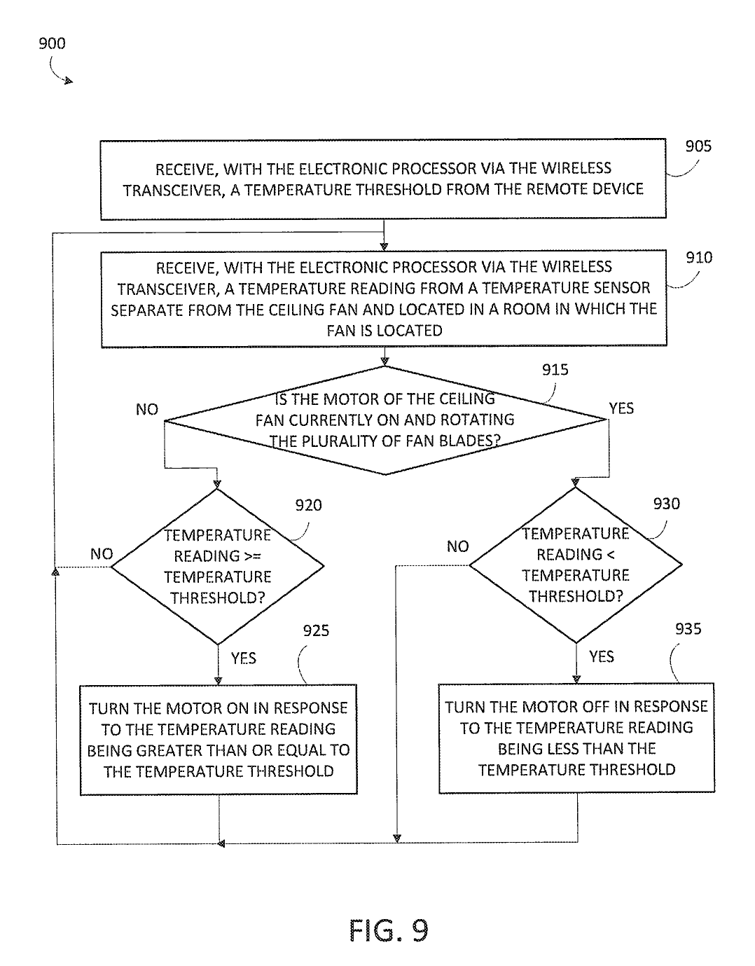

FIG. 9 is a flowchart of a method 900 for controlling the ceiling fan 105 based on a temperature input (e.g., a signal or reading) from a temperature sensor. At block 905, the ceiling fan 105 may receive a temperature threshold from the remote device 110. For example, the remote device 110 may transmit the temperature threshold to the ceiling fan 105 in response to receiving a user selection of the temperature threshold via the user interface 120. The ceiling fan electronic processor 305 may store the temperature threshold in the ceiling fan memory 310. At block 910, the ceiling fan electronic processor 305 may receive a temperature reading from a temperature sensor. In some embodiments, the temperature sensor may be integrated with the ceiling fan 105. However, in other embodiments, the temperature sensor may be separate from the ceiling fan 105 and may be located in a room or area in which the ceiling fan 105 is located. For example, the separate temperature sensor may be located in the remote device 110 or may be a stand-alone thermostat device. Using a temperature sensor separate from the ceiling fan 105 may be useful because the separate temperature sensor may more accurately represent the temperature in the room or area as experienced by the user. For example, because heat rises, a temperature near the ceiling fan 105 may be hotter than a temperature of an area more proximate a floor of the room or area.

At block 915, the ceiling fan electronic processor 305 may determine whether the primary motor 345 is currently on and rotating the plurality of fan blades 130. When the primary motor 345 is not currently on, at block 920, the ceiling fan electronic processor 305 may determine whether the received temperature reading satisfies the temperature threshold. When the received temperature reading does not satisfy the temperature threshold, the method 900 may proceed back to block 910 to continuing monitoring received temperature readings. When the received temperature reading satisfies the temperature threshold, at block 925, the ceiling fan electronic processor 305 may supply power to the primary motor 345 in response to the temperature reading satisfying the temperature threshold. The method 900 may then proceed back to block 910 to continue monitoring the received temperature readings.

Returning to block 915, when the primary motor 345 is currently on, at block 930, the ceiling fan electronic processor 305 may determine whether the received temperature reading satisfies a second temperature threshold. For example, a user may set an upper temperature threshold (e.g., a first temperature threshold), at or above which the ceiling fan turns on, and a lower temperature threshold (e.g., a second temperature threshold), below which the ceiling fan may turn off. When the received temperature does not satisfy the second temperature threshold, at block 935, the method 900 may proceed back to block 910 to continuing monitoring received temperature readings. When the received temperature reading satisfies the temperature threshold, at block 935, the ceiling fan electronic processor 305 may turn the primary motor 345 off in response to the temperature reading being less than the temperature threshold. The method 900 may then proceed back to block 910 to continue monitoring received temperature readings. In this way, the method 900 may allow the temperature of a room or area in which the ceiling fan 105 is located to be maintained around a desired temperature (e.g., proximate to the first and/or second temperature thresholds) set by the user on the remote device 110.

Although at blocks 925 and 935 of FIG. 9, the ceiling fan electronic processor 305 turns the primary motor 345 on/off in based on a comparison of the temperature reading to a temperature threshold, in some embodiments, at block 925 and 935, the ceiling fan electronic processor 305 may perform other operations. For example, at block 925, the ceiling fan electronic processor 305 may increase a rotational speed of the primary motor 345 to generate more airflow. Similarly, at block 935, the ceiling fan electronic processor 305 may decrease the rotational speed of the primary motor 345 to generate less airflow.

In some embodiments, the ceiling fan 105 may transmit a notification to the remote device 110 to be provided to the user each time the operation of the primary motor 345 is adjusted in accordance with the method 900. Although the above explanation of the method 900 involves the ceiling fan electronic processor 305 determining whether received temperature readings are above or below the temperature threshold, in some embodiments, this determination may be made by a separate device where the separate temperature sensor is located. For example, the remote device 110 may determine whether the primary motor 345 should be turned on/off based on temperature readings from the integrated temperature sensor (e.g., 230, FIG. 2) and may send corresponding instructions/commands to the ceiling fan 105. In some embodiments, the method 900 may include a single temperature threshold (e.g., above/below which the fan turns on/off) or a turn-on temperature threshold and a turn-off temperature threshold that are different values.

In some embodiments, the remote device 110 may track an outside temperature or a season of the year. In such embodiments, the remote device 110 may send instructions to the ceiling fan 105 to change an operational parameter of the ceiling fan 105 (e.g., reverse a rotational direction of the fan blades 130) in response to the outside temperature or the season. Alternatively, the remote device 110 may provide a notification to a user to remind the user to change an operational parameter of the ceiling fan 105 in response to the outside temperature of the season.

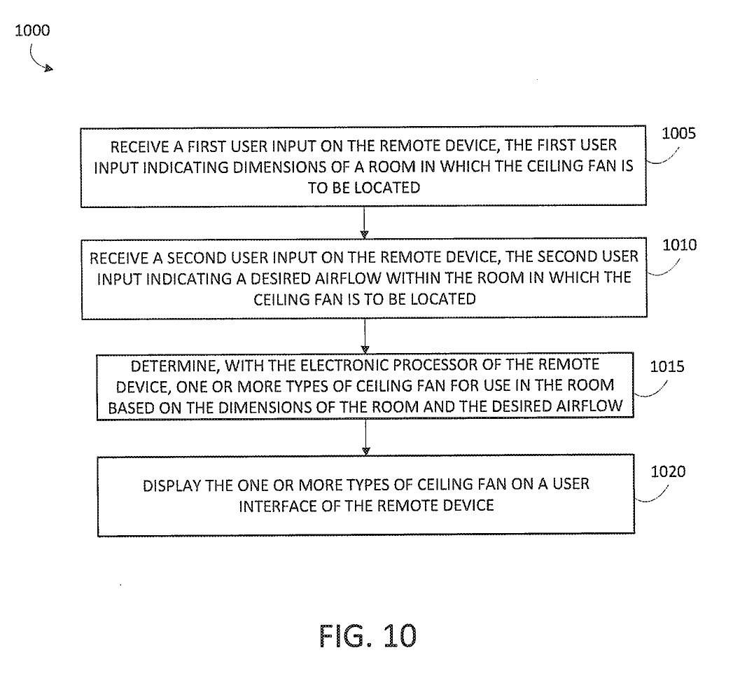

FIG. 10 is a flowchart of a method 1000 of optimizing circulation for a room or area based on determining an optimal ceiling fan for the room or area in which the ceiling fan 105 is to be installed. Optimizing circulation may include providing an optimally sized fan, an energy efficient fan, a fan having optimal specifications, a fan having optimal settings (e.g., optimal speed, direction, fan blade pitch, and/or the like) and/or the like for providing optimal circulation of air in the room or area.

At block 1005, the remote device 110 may receive a first user input indicating dimensions (e.g., height, width, length) of a room in which the ceiling fan 105 is to be located. The user input may also identify and/or indicate other types and/or locations of thermal structures (e.g., fireplaces, windows, doors, etc.) disposed in the room or area.

At block 1010, the remote device 110 may receive a second user input indicating a desired airflow within the room in which the ceiling fan 105 is to be located. For example, the desired airflow may be entered on a sliding scale from maximum airflow to minimum airflow, from maximum temperature to minimum temperature, and/or the like. At block 1015, the remote device electronic processor 205 may determine at least one type (e.g., brand, bladed, bladeless, and/or the like) of ceiling fan for use in the room based on the dimensions of the room, thermal dynamics of the room, and/or the desired airflow. For example, the remote device electronic processor 205 may access a look-up table stored in the remote device memory 210 or accessible via an external database. The look-up table may include types of ceiling fans and appropriate ranges of square footage and desired airflow that each type of ceiling fan was designed to accommodate. Additionally, or alternatively, the remote device electronic processor 205 may determine the optimal ceiling fan for a room based on executing a model that inputs the room dimensions, thermal dynamics, and/or the desired airflow and outputs an optimal ceiling fan based on the model. In this way, the remote device electronic processor 205 may intelligently select a fan based on actual data associated with the room. Additionally, or alternatively, the remote device electronic processor 205 may determine the optimal placement for a ceiling fan in a room based on a model that inputs the room dimensions, thermal dynamics, and/or the desired airflow and outputs spatial coordinates of the optimal placement of the ceiling fan in the room based on the model.

At block 1020, the remote device electronic processor 205 may cause the user interface 120 to display one or more types of ceiling fans (e.g., fan sizes, fan shapes, fan technologies, fan brands, and/or the like) to be viewed by the user. The user may interface with the remote device 110 to facilitate a purchase a desired ceiling fan directly via the user interface 120 (e.g., using an “app”), or save displayed information regarding the one or more types of ceiling fans in order to later purchase a desired ceiling fan from a merchant.

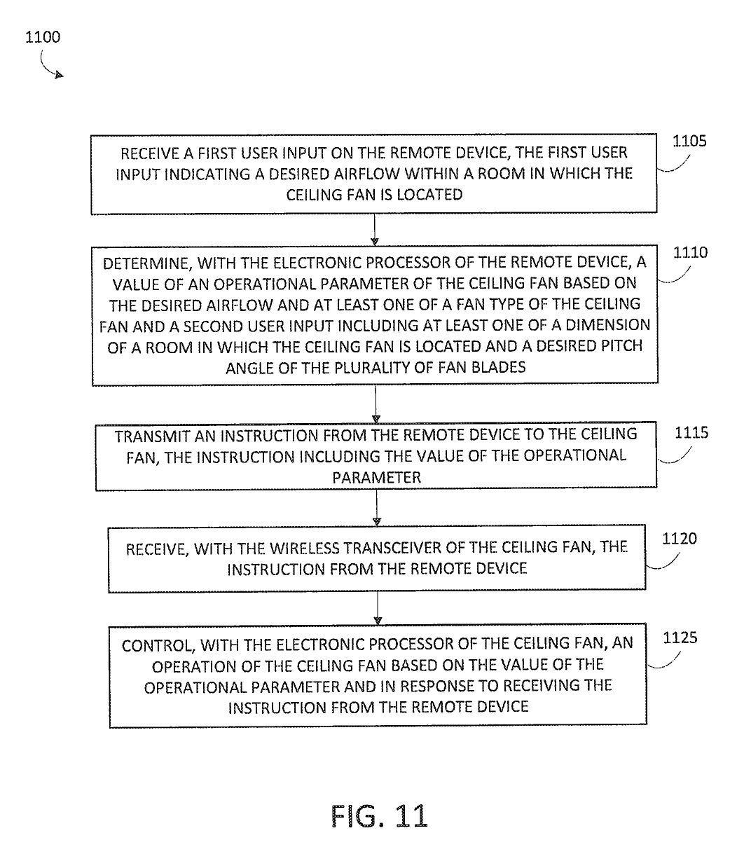

FIG. 11 is a flowchart of a method 1100 of controlling the ceiling fan 105 to generate a desired airflow in accordance with user inputs. The ceiling fan electronic processor 305 or the remote device electronic processor 205 may determine at least one operational parameter (e.g., a rotational speed, a rotational direction, a fan blade pitch angle, and/or the like) of the ceiling fan 105 to provide a desired airflow within the room or area in which the ceiling fan 105 is located.

At block 1105, the remote device 110 may receive a first user input indicating a desired airflow within the room or area in which the ceiling fan 105 is located. For example, the desired airflow may be entered on a sliding scale from maximum airflow to minimum airflow, and/or the like. At block 1110, the remote device electronic processor 205 may determine a value of an operational parameter of the ceiling fan 105 based on the desired airflow and at least one of a fan type of the ceiling fan 105 and a second user input including at least one of dimensions of the room or area in which the ceiling fan 105 is located and a desired pitch angle of the plurality of fan blades 130. At block 1115, the remote device 110 may transmit an instruction including the value of the operational parameter to the ceiling fan 105. At block 1120, the ceiling fan 105 may receive the instruction from the remote device 110. At block 1125, the ceiling fan electronic processor 305 may control an operation of the ceiling fan 105 based on the value of the operational parameter and in response to receiving the instruction from the remote device 110.

As one example implementation of the method 1100, the remote device 110 may determine a speed of rotation of the primary motor 345 and a pitch angle of the fan blades 130 in which to operate the ceiling fan 105 based on the desired airflow and/or the type of ceiling fan.

As another example implementation of the method 1100, the remote device 110 may determine a speed of rotation of the primary motor 345 and a pitch angle of the fan blades 130 in which to operate the ceiling fan 105 based on the desired airflow and the dimensions of the room or area in which the ceiling fan 105 is located.

As yet another example implementation of the method 1100, the remote device 110 may determine a speed of rotation of the primary motor 345 and a rotational direction of the primary motor 345 in which to operate the ceiling fan 105 based on the desired airflow and a user-selected desired pitch angle of the fan blades 130. Adjusting parameters such as speed of the primary motor 345, rotational direction of the primary motor 345, and pitch angle of the fan blades 130 may provide different predetermined airflow patterns of varying strength in accordance with the desired airflow of the user (e.g., mostly downward air patterns, mostly horizontal air patterns, etc.).

Some embodiments are described herein in connection with thresholds. As used herein, satisfying a threshold may refer to a value being greater than the threshold, more than the threshold, higher than a threshold, greater than or equal to a threshold, less than the threshold, fewer than the threshold, lower than the threshold, less than or equal to the threshold, equal to the threshold, or the like.

Throughout the above description numerous sensors are described (e.g., the separate sensor device(s) 147, the sensor 230 of the remote device 110, and the sensor 337 of the ceiling fan 105). As indicated by FIG. 1 and the above description, information obtained by one or more of these sensors may be communicated over the network 112 to another device in the system 100. For example, the remote device 110 and/or the ceiling fan 105 may obtain the information from one or more of the sensors via communication over the network 112. In other words, the remote device 110 and/or the ceiling fan 105 may obtain information from their own built-in sensors or from sensors of another device (e.g., the separate sensor device 147 that may include a separate housing and may be located in a room or area where the ceiling fan 105 is located). In some embodiments, the sensor 230 of the remote device 110 and/or the sensor 337 of the ceiling fan 105 may be referred to as sensor devices. In other words, a sensor device may be disposed in the remote device 110, the fan 105, and/or a room in which the fan 105 is located and separate from the remote device 110 and the fan 105.

Various features and advantages of the present subject matter are set forth in the following claims.

We claim:

1. A system comprising:
a sensor device;
a remote device communicatively coupled to the sensor device,
the remote device being configured to:
obtain data from the sensor device,
generate an instruction based on the data obtained from the sensor device,
access a communications network, and
transmit the instruction via the communications network;
a fan connected to the communications network, the fan comprising:
a hub;
a plurality of fan blades extending from the hub;
a motor supported by the hub,
the motor being configured to rotate the plurality of fan blades;
a wireless transceiver supported by the hub,
the wireless transceiver being configured to access the communications network for communicating with the remote device; and
an electronic processor supported by the hub,
the electronic processor being configured to control an operation of the fan based on receiving the instruction from the remote device via the wireless transceiver.

2. The system of claim 1, wherein:
the instruction includes a lock command, and
the electronic processor is configured to cause the plurality of fan blades to lock respective to the hub based on receiving the lock command.

3. The system of claim 2, wherein:
the electronic processor is configured to receive a second instruction from the remote device via the wireless transceiver, and
the electronic processor is configured to cause the plurality of fan blades to unlock respective to the hub based on receiving the second instruction.

4. The system of claim 1, wherein:
the instruction indicates a fan blade pitch angle, and
the electronic processor is configured to cause at least one secondary motor of the fan to adjust a fan blade to the fan blade pitch angle respective to the hub based on receiving the instruction.

5. The system of claim 1, wherein the sensor device is disposed in:
the remote device,
the fan, or
a room in which the fan is located and separate from the remote device and the fan.

6. The system of claim 1, wherein:
the sensor device comprises an impact sensor, and
the electronic processor is configured to monitor impacts experienced by the plurality of fan blades using the impact sensor.

7. The system of claim 6, wherein the electronic processor is configured to lock the plurality of fan blades respective to the hub based on a monitored impact detected by the impact sensor satisfying an impact threshold.

8. The system of claim 1, wherein:
the fan is configured to receive power from a mains alternating-current (AC) power supply for powering the motor and a light, and
the electronic processor is configured to detect a loss of power from the mains AC power supply and power the motor and the light using energy stored in a backup battery based on detecting the loss of power.

9. The system of claim 1, wherein the instruction includes at least one of:
an on/off command for the motor,
a rotation speed adjustment for the motor,
a rotation direction setting for the motor, and
an on/off command for a light included on the fan.

10. The system of claim 1, wherein:
the instruction indicates a schedule of operation times for the fan, and
the electronic processor is configured to cause, in accordance with the operation times, at least one of:
(i) the motor to power on/off, and
(ii) at least one of a scented spray and a bug repellant to be dispensed.

11. The system of claim 9, wherein the electronic processor is configured to cause the fan to rotate differently at different operation times included in the schedule of operation times.

12. The system of claim 1, wherein the remote device is configured to:
obtain dimensional inputs for a room in which the fan is to be placed, and
execute a model to determine an optimal type of fan for placement in the room based on the dimensional inputs.

13. The system of claim 1, wherein the remote device is configured to:
obtain dimensional inputs and thermal inputs for a room in which the fan is to be placed, and
execute a model to determine optimal fan settings for placement in the room based on the dimensional inputs and the thermal inputs.

14. The system of claim 13, wherein the fan settings include at least one of:
a rotational direction of the fan,
a rotational speed of the fan, and
a pitch angle associated with a fan blade of the plurality of fan blades.

15. The system of claim 1, wherein:
the sensor device comprises a temperature sensor configured to obtain temperature data,
the instruction includes a temperature threshold, and
the electronic processor is configured to compare the temperature data and the temperature threshold and cause an action to be performed based on comparing the temperature data and the temperature threshold.

16. The system of claim 15, wherein the action includes:
powering the fan on,
powering the fan off,
increasing a rotational speed of the fan blades, or
decreasing the rotational speed of the fan blades.

17. A method of controlling a fan, the method comprising:
obtaining, by an electronic processor of a remote device communicatively coupled to a sensor device, data from the sensor device;
generating, by the electronic processor, an instruction based on the data obtained from the sensor device,
wherein the instruction indicates and action to be performed by the fan;
accessing, by the electronic processor, a communications network;
transmitting, by the electronic processor, the instruction to the fan via the communication network; and
causing, by the electronic processor, the fan to perform the action indicated in the instruction.

18. The method of claim 17, wherein the instruction includes a lock command, the electronic processor being configured to cause the plurality of fan blades to lock respective to the hub based on receiving the lock command.

19. The method of claim 17, wherein the instruction indicates a fan blade pitch angle, the electronic processor being configured to cause at least one secondary motor of the fan to adjust a fan blade to the fan blade pitch angle respective to the hub based on receiving the instruction.

20. The method of claim 17, wherein the sensor device is disposed in:
the remote device,
the fan, or
a room in which the fan is located and separate from the remote device and the fan.

21. The method of claim 17, wherein the fan is configured to receive power from a mains alternating-current (AC) power supply for powering the motor and a light, the electronic processor being configured to:
detect a loss of power from the mains AC power supply; and
cause the fan to power the motor and the light using energy stored in a backup battery based on detecting the loss of power.

22. The method of claim 17, wherein the instruction indicates a schedule of operation times for the fan, the electronic processor being configured to cause, in accordance with the operation times, at least one of:
(i) the motor to power on/off, and
(ii) at least one of a scented spray and a bug repellant to be dispensed.

23. The method of claim 17, wherein obtaining the data from the sensor device includes obtaining temperature data from a temperature sensor; and
wherein the instruction includes a temperature threshold, the electronic processor being configured to compare the temperature data and the temperature threshold and cause the action to be performed based on comparing the temperature data and the temperature threshold, wherein the action includes:
powering the fan on,
powering the fan off,
increasing a rotational speed of the fan blades, or
decreasing the rotational speed of the fan blades.
